(19) United States
(12) Patent Application Publication
(10) Pub. No.: US 2026/0339986 A1
(43) Pub. Date: Oct. 29, 2026

(54) METHODS AND SYSTEMS FOR COMPARING SEMANTIC SIMILARITY WITHIN DOCUMENTS USING SIAMESE NEURAL NETWORKS

(71) Applicant: Avodah, Inc., Wilmington, DE (US)

(72) Inventor: Gregory Nathan Toepperwein, Ypsilanti, MI (US)

(21) Appl. No.: 19/578,567

(22) Filed: Mar. 25, 2026

Related U.S. Application Data
(60) Provisional application No. 63/777,476, filed on Mar. 25, 2025.

(51) Int. Cl. G06F 16/31; G06F 40/30; G06F 40/58; G06N 3/08

(52) U.S. Cl. CPC G06F 16/322; G06F 40/30; G06F 40/58; G06N 3/08

(57) ABSTRACT

Methods and systems for using a Siamese neural network for comparing semantic similarity within documents are described. An example method includes performing a textual analysis operation on a first document comprising multiple units of text in a hierarchical structure to generate an embedding table for the first document, and generating training data by determining the semantic similarity between pairs of units of text from the first document. The method further includes training a Siamese neural network with the embedding table and the training data as inputs, and determining, based on using the trained Siamese neural network, the semantic similarity between pairs of units of text from a second document organized in the hierarchical structure. The determined sematic similarity enables updating or verifying a translation of the second document. An example system includes one or more processors configured to implement the Siamese neural network and/or the above-described method.

### CROSS-REFERENCE TO RELATED APPLICATION

This application claims the benefit of priority to U.S. Provisional Patent Application No. 63/777,476, entitled “SIAMESE NEURAL NETWORKS FOR COMPARING SEMANTIC SIMILARITY WITHIN DOCUMENTS,” and filed on Mar. 25, 2025. The entire contents of the before-mentioned patent application are incorporated by reference as part of the disclosure of this application.

### TECHNICAL FIELD

This document generally relates to neural networks, and more particularly, to using Siamese neural networks to quantify semantic similarity within documents.

### BACKGROUND

Neural networks have revolutionized the field of natural language processing (NLP) by providing powerful tools for understanding and generating human language. These networks, particularly deep learning models, excel at capturing complex patterns and relationships within text data, and have been applied to multiple aspects of NLP that include morphological analysis, sentiment analysis, semantic analysis, corpus linguistics, machine translation, and the like. Neural networks have significantly enhanced the capabilities of NLP systems, enabling more accurate and context-aware language processing.

### SUMMARY

Embodiments of the disclosed technology are directed to methods and systems for determining, in a language-agnostic framework, semantic similarity between multiple different-language documents that are organized in the same hierarchical framework. In an example, computational methods for clustering the books of the Bible based solely on their textual content are provided. A Siamese model architecture was leveraged to compare the semantic similarity between verses. Separate versions of the model were trained on each of three different language translations of the Bible (English New International Version—NIV, French Segond, and Indonesian Alkitab Yang Terbuka—AYT). These models generated encodings to cluster the books based on similarity. The resultant clusters generally align with traditional understandings of how the books of the Bible relate to one another. The described embodiments provide a technological solution for determining the efficacy of translations (under a sematic similarity metric) of different-language documents that are organized in similar hierarchies. A non-limiting example discussed in this patent document is the approach to the translation and understanding of whether Biblical writings are interrelated.

In an example aspect, a method for improving translation capabilities of hierarchically-organized documents based on semantic similarity is described. The method includes performing a textual analysis operation on a first document comprising multiple units of text in a hierarchical structure to generate an embedding table for the first document, and generating training data by determining the semantic similarity between pairs of units of text from the multiple units of text from the first document. Herein, the training data comprises (a) a positive semantic similarity sample generated based on two units of text from a same subsection of the first document and (b) a negative semantic similarity sample generated based on an original unit of text and an inverted unit of text generated by flipping an order of the original unit of text. The method further includes training a Siamese neural network with the embedding table and the training data as inputs to generate a trained Siamese neural network that is configured to provide a scalar value indicative of the semantic similarity between an input pair of units of text, and determining, based on using the trained Siamese neural network, the semantic similarity between pairs of units of text from a second document comprising multiple units of text in the hierarchical structure. The determined sematic similarity enables an update to or a verification of a translation of the second document.

In another example aspect, the above-described method may be implemented by an apparatus or device that includes a processor and/or memory.

In yet another example aspect, this method may be embodied in the form of processor-executable instructions and stored on a computer-readable program medium.

The subject matter described in this patent document can be implemented in specific ways that provide one or more of the following features.

### BRIEF DESCRIPTION OF THE DRAWINGS

FIG. 1 illustrates a flow diagram of an example method for using a Siamese neural network for comparing semantic similarity within documents.

FIGS. 2A-2D illustrate flow diagrams for the individual operations in FIG. 1.

FIG. 3A illustrates a dendrogram of books in the English NIV Bible based on implied thematic similarity, and FIGS. 3B-3D illustrate the leaves of the dendrogram.

FIG. 4 is an example of a heatmap of similarity between pairs of books.

FIGS. 5A-5C illustrate a dendrogram of books in the Indonesian AYT Bible based on implied thematic similarity, and FIGS. 5B and 5C illustrate the leaves of the dendrogram.

FIGS. 6A-6C illustrate a dendrogram of books in the French Segond Bible based on implied thematic similarity, and FIGS. 6B and 6C illustrate the leaves of the dendrogram.

FIG. 7 illustrates a flowchart for a method for improving translation capabilities of hierarchically-organized documents based on semantic similarity.

FIG. 8 is a block diagram illustrating an example system configured to implement embodiments of the disclosed technology.

### DETAILED DESCRIPTION

Neural networks have become a cornerstone in natural language processing (NLP), particularly for tasks involving semantic similarity. Semantic similarity refers to the process of determining how much two pieces of text are alike in meaning. Neural networks, especially deep learning models, have shown remarkable efficacy in capturing the nuances of language and understanding context, which are critical for assessing semantic similarity.

One of the most prominent neural network architectures used for this purpose is the Siamese network. Siamese networks consist of two identical subnetworks that process two input texts simultaneously. These subnetworks share the same weights, ensuring that both inputs are transformed in the same way. The outputs are then compared using a distance metric, such as cosine similarity, to determine the degree of semantic similarity. This architecture is particularly effective because it ensures that similar texts are mapped to nearby points in the vector space, while dissimilar texts are mapped to distant points.

Section headings are used in the present document to improve readability of the description, and do not in any way limit the discussion or the embodiments (and/or implementations) to the respective sections only.

### 1 Introduction

Translation is much more than converting words; meaning, context, and cultural nuance should also be understood. Central to this process is the concept of themes, which serve as the underlying threads that connect ideas and emotions within a text. By examining themes, translators can gain insights into the broader implications of a work, allowing them to make informed choices that go beyond literal translation. In the context of translation, considering themes prompts significant questions about fidelity to the source material versus the necessity of adaptation for the target audience. Translators may need to navigate the delicate balance between preserving the original message and making it resonate within a different cultural framework. This involves not merely linguistic skills but also a keen awareness of the thematic elements that shape a text's identity.

Moreover, themes can illuminate the values, beliefs, and social constructs inherent in both the source and target cultures. By analyzing these thematic dimensions, translators can approach their work with a more nuanced perspective, questioning how specific themes might be interpreted differently across cultures and how they can be effectively conveyed to maintain the integrity of the original message. This disclosure aims to explore these dynamics, raising questions that challenge traditional notions of translation and encouraging a more thoughtful engagement with the themes that lie at the heart of cross-cultural communication.

### 2 Example Embodiments for Cross-Document Semantic Similarity

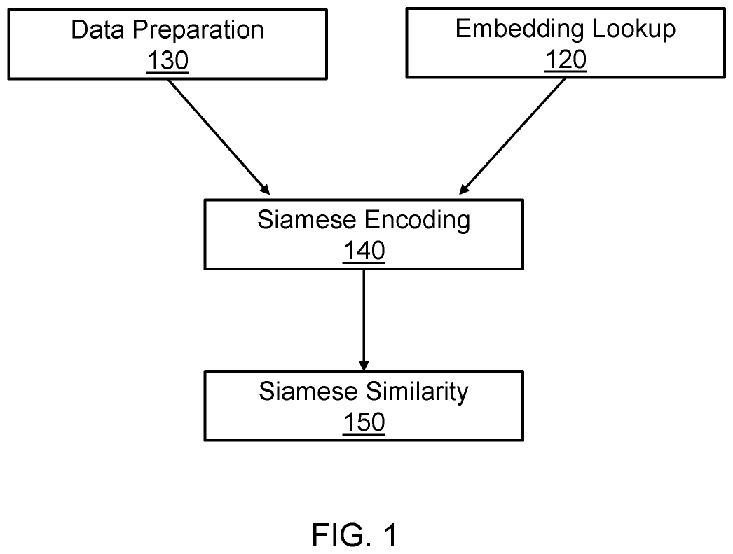

FIG. 1 illustrates a flow diagram of an example method for using a Siamese neural network for comparing semantic similarity within documents, in accordance with the disclosed embodiments. As shown therein, the method includes performing an embedding lookup operation (120) and a data preparation operation (130), the outputs of which are provided as inputs to a Siamese encoding operation (140), whose output is in turn processed by a Siamese similarity operation (150) to produce a measure of semantic similarity between pairs of units of text.

In some embodiments, generating an embedding lookup table includes transforming words into dense vector representations that capture their meanings and relationships. This process typically involves training a neural network on a large corpus of text to learn these embeddings. Once trained, the model produces a lookup table where each word is associated with a unique vector. These vectors are positioned in a high-dimensional space such that words with similar meanings are located close to each other. This spatial arrangement allows for efficient computation of semantic similarity and other linguistic properties.

In some embodiments, the creation of a embedding lookup table is based on continuous bag of words (CBOW) methods that:
define span of “nearby words” based on full Biblical verses instead of distance
instead of using words, use tokens from M2M model (e.g., using the tokenizer designed for a transformer-based model instead of one designed for more traditional NLP techniques)
rather than fitting with a neural network, create a simple association matrix, and then compress via principal component analysis (PCA)

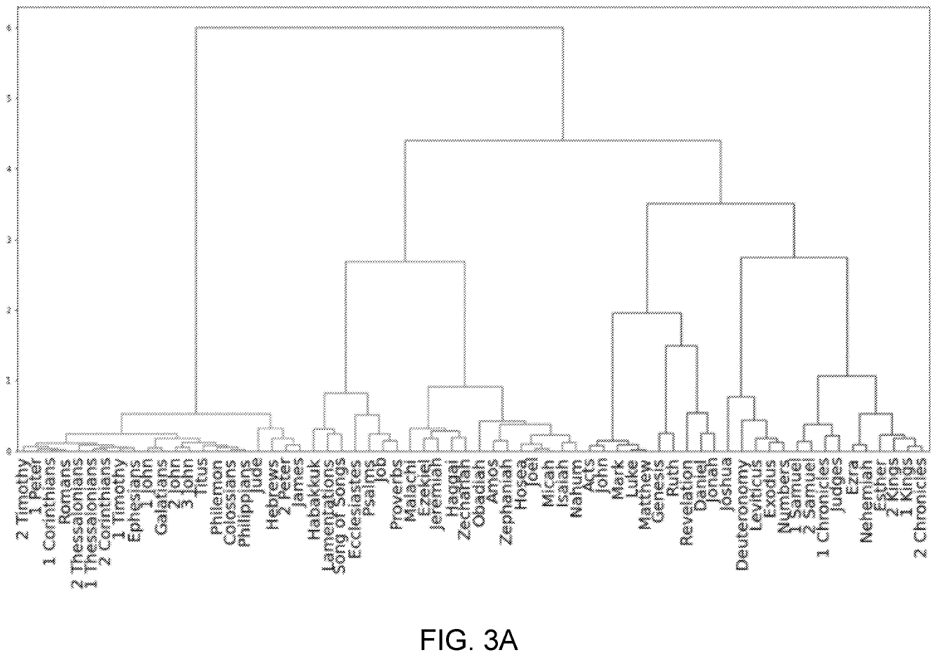

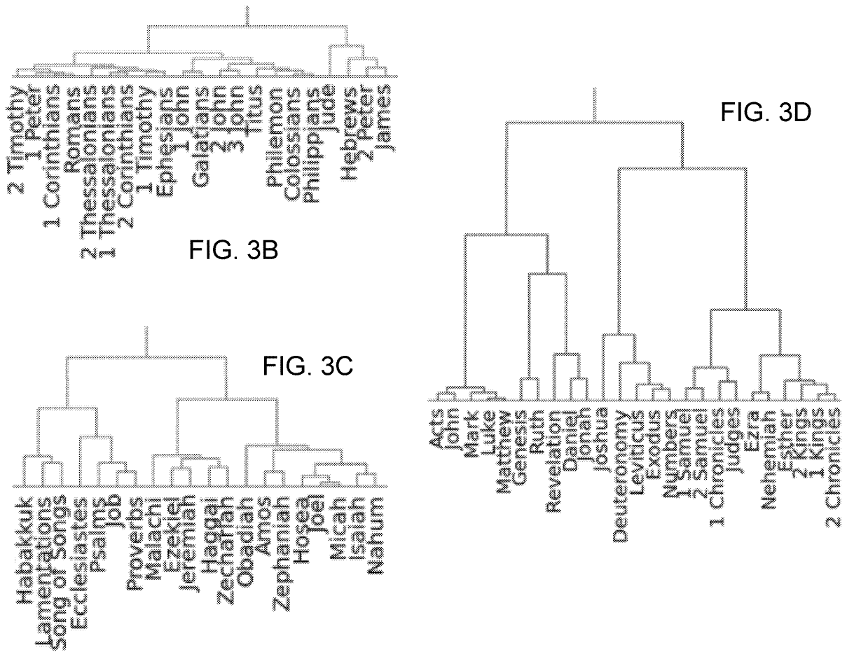

This approach results in an embedding table that is language independent, which advantageously enables the described embodiments to be applied to language texts in any language, e.g., the English NIV Bible, the Indonesian AYT Bible, and the French Segond Bible, which are used as examples to generate representative dendrograms of books in the respective Bible as illustrated in FIGS. 3A, 5A and 6A, respectively.

In some embodiments, generating training data to train a neural network for semantic analysis involves preprocessing the collected text (e.g., a representative dataset), which includes tasks like tokenization, removing stop words, and normalizing text to a consistent format. Annotating the data with semantic labels is a critical step, often requiring human expertise to ensure accuracy. For instance, pairs of sentences might be labeled with similarity scores, or texts might be categorized by topic. This labeled data serves as the ground truth for training the neural network. Additionally, techniques like data augmentation can be employed to artificially expand the dataset, enhancing the model's robustness.

In some embodiments, “whether verses were in same book or not” was used as a proxy for “similar thematic style”. In other embodiments, and for a pair of verses that are matching, a negative sample in a synthetic set is generated by flipping one verse backwards and marking it as not matching.

As discussed above, the outputs of the embedding lookup (120) and data preparation (130) operations are input into a Siamese encoding (140) operation, and its output is processed by a Siamese similarity (150) operation.

In some embodiments, the encoding operation of the Siamese neural network transforms input data into meaningful vector representations. In a Siamese network, two identical subnetworks, each with the same architecture and shared weights, process two input samples simultaneously. These subnetworks typically consist of layers such as convolutional layers, recurrent layers, or fully connected layers, depending on the nature of the input data. During encoding, each subnetwork independently processes its input, extracting features and transforming the data into a fixed-size vector, known as an embedding. The shared weights ensure that both inputs undergo the same transformation, preserving the consistency of the feature extraction process.

In some embodiments, a 2-layer Bidirectional LSTM model with dropout, layer normalization, and regularization is used.

In some embodiments, the output vector is of size 12. This is unusually low, and an intentional choice to limit the potential complexity the model can hope to represent. This is, in part, motivated by limiting the potential of the model to memorize training data, thereby ensuring the creation of a generalizable representation.

In some embodiments, and after the encoding process, the resulting vector representations are fed into a similarity function, such as Euclidean distance or cosine similarity. This function calculates a similarity score that quantifies how alike the two inputs are. The network is trained to minimize the distance for similar pairs and maximize it for dissimilar pairs.

In some embodiments, cosine similarity is scaled with a dense layer and sigmoid to transform into a probability.

In some embodiments, kernel constraints are applied to the dense layer prevent noisy data from driving weights to zero initially, so they could stabilize during fitting.

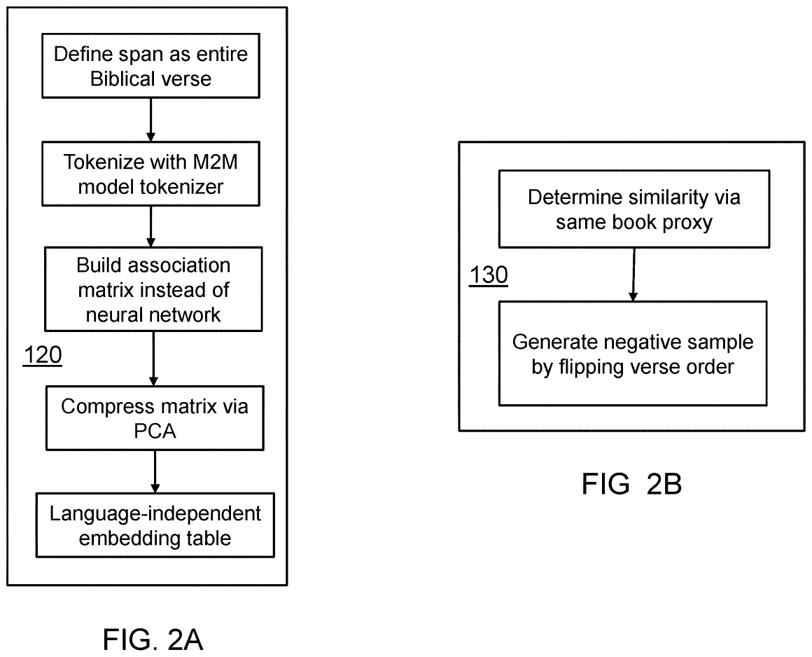

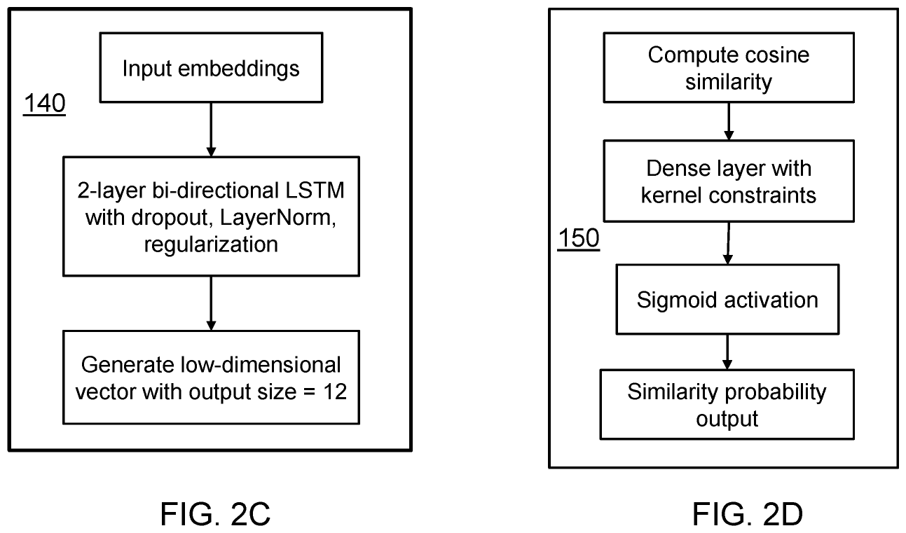

FIGS. 2A-2D illustrate flow diagrams for the embedding lookup (120), data preparation (130), Siamese encoding (140), and Siamese similarity (150) operations in FIG. 1 being applied to comparing the semantic similarity amongst Bible verses, respectively.

FIG. 2A illustrates the embedding lookup operation (120), in which a span is defined as an entire Biblical verse, text is tokenized using a machine-to-machine (M2M) model tokenizer, an association matrix is built in place of a neural network, the matrix is compressed via principal component analysis (PCA), and a language-independent embedding table is generated.

FIG. 2B illustrates the data preparation operation (130), in which semantic similarity between verses is determined using a same-book proxy, and negative samples are generated by flipping the order of a verse.

FIG. 2C illustrates the Siamese encoding operation (140), in which a two-layer bidirectional LSTM model with dropout, layer normalization, and regularization processes input embeddings and generates a low-dimensional output vector with a size of 12.

FIG. 2D illustrates the Siamese similarity operation (150), in which cosine similarity is computed between the encoded vectors, passed through a dense layer with kernel constraints and a sigmoid activation function, and output as a similarity probability.

### 3 Example Embodiments for Biblical Translations

Scholars have long clustered the books of the Bible in various ways to aid the study and understanding of the scripture. Typically, the choice of how to divide books is heavily based on authorship and when the book was written. It is common practice, for example, to treat the books written by prophets as one set, sometimes subdividing this cluster into the major and minor prophets. This basis is not without challenges owing to both disagreements about authorship (2 Peter) and difficulty in estimating the date of writings (Joel). In some examples, the described embodiments produce a meaningful clustering of the books based upon their own text, without the aid of external information. In this sense, the themes and style of a book are intrinsic to its character, rather than being derived from details of how scripture was captured. Unlike text classification, which would simply identify which of previously established genres a particular book or verse belongs to, the problem of text clustering exists where no assumption is made a priori regarding the number of clusters or how they should be interrelated. Herein, there are used Siamese networks to compare the semantic similarity between verses and construct a vector-space amiable to various common clustering methods. Rather than rely on the extensive body of work evaluating semantics in well-studied languages, the methods described below do not depend on the language used. They can be repeated in common and rare languages alike.

### 3.1 Data Preparation

The thematic nature of books within the Bible will likely be impacted by translation. In recognition of this, the disclosed technology provides a methodology applicable across languages. In some embodiments, the text that is evaluated is in the same language, e.g., precluding direct evaluation of original text whose New Testament and Old Testament are in different languages. It is noted that the inclusion or exclusion of headers had no substantive impact on results. All other additional text (footnotes, introductions, etc.) are excluded. Text for this study was taken from three versions of the Bible: the English New International Version (NIV), the French Segond, and the Indonesian Alkitab Yang Terbuka (AYT). Sixty-six chapters were selected at random as testing verses. This is one chapter per book, on average, but selection was random, so several of the shorter books do not appear in the testing verses, while at the other extreme 9 chapters of Psalms do. All other chapters are included in the training verses.

In the described embodiments, a multilingual encoder-decoder (seq-to-seq) model, e.g., the M2M100 tokenizer, is used to convert each verse to a list of tokens. As the model is multilingual it expects the sequences in a certain format: A language id token is used as prefix in both the source and target text. The source text format is [lang_code] X [eos], where lang_code is source language id for source text and target language id for target text, with X being the source or target text. Additional details regarding the M2M100 model and its implementation is available in “Beyond English-Centric Multilingual Machine Translation” by Fan et al. (2020) and the corresponding repository on Hugging Face.

The above-described tokenization process can be thought of as breaking a verse down into a list of short segments roughly the size of a morpheme, but falling back to single-characters when a rare combination is encountered. Tokens were sorted by frequency and re-indexed such that the most common token has the lowest index. Any token occurring fewer than 3 times was replaced by a generic rare word token and placed at the beginning of the token list. The tokens in the training verses are used for this determination and any token occurring in the test set that does not appear in the training verses is treated as a rare token.

Note that this tokenization is done separately for each Bible, so the token frequencies reflect how common those character combinations are in their respective languages. As part of the model described below, tokens will pass through an encoding layer. By its nature the encoding layer will contain 100,000s of parameters. Fitting a model from scratch with so many parameters requires a far larger corpus than the Bible itself. However, using an off-the-shelf option would limit the applicability of these methods to major languages that have such embeddings well-trained. Additionally, names such as Moses, Abraham, and Solomon can often be stripped of their importance in such language embeddings. To bridge the need for encoding without relying on non-Biblical text, an approximate encoding is desirable. Note that using non-Biblical text is not inherently problematic, but for translation projects of rare languages it may be that the sole available text the translation team has access to in that language is the Bible they are working on. As such, it is preferable to develop a methodology with no additional external dependencies.

### 3.2 Semantic Similarity

An association matrix was generated that captured, for each token, which of the 1024 most-frequent tokens it co-occurred with on a verse level. In this way, words that appear interchangeably, such as many of the names in chronologies, would have identical or near-identical representations. The dimensionality was further reduced through Principal Components Analysis (PCA) to 128 to create the initial encodings. The encodings produced by the method are not an optimal representation but act as a way to bootstrap training to an initial state. Data in the training verses is used to build the initial encoding. Before diving into details of how the training set was produced from the tokenized verses, it is valuable to provide a brief description of the conceptual framework of machine learning for those less familiar with the topic.

The described embodiments provide insight into the thematic relationship between verses in the Bible. The model form selected takes in two verses and outputs a prediction of whether or not they are similar. Humans have a multi-level conception of similarity that reflects upon the meaning, style, emotional impact, and several other aspects of writing to determine if verses are similar. In the mathematical world of machine learning, similarity is a quantitative metric measuring how closely aligned vectors are. The question becomes how to bring the mathematical definition closer to the human interpretation. The short answer is that the model's conceptual understanding is dictated by the examples through which it is trained. Supervised learning enables a model that is exposed to input-output pairs can adjusts its internal parameters so its predictions better match the approved output values. The mechanics of that process aside, it relies on training data that accurately reflects the human-imposed definitions of the correct output. However, there is no dataset that unambiguously compares pairs of Bible verses and says whether or not they are similar. To build a sufficiently large dataset by hand in every potential language of translation would be impractical. Instead, a short-cut can be taken to create a dataset that will reasonably align with human judgment of similarity yet be feasible to implement. This interpretation issue provides a definition of similarity in the model being determined by how the training set is defined. This is true of every machine learning model, but it is a more visible and notable part of the conversation here because it is constructed from limited data. A training set is built by aggregating pairs of verses as the inputs and assigning a value of 1 or 0 as the desired model output, representing similar or dissimilar verse pairs respectively.

The simplest available proxy for similarity is whether the two verses appear in the same book. This definition is enough to provide a basis for what similarity means, but it is flawed for constructing a training dataset to learn thematic style. Machine learning models are quite apt at finding simplifying shortcuts, and in this case, references to specific persons or places can be sufficient to determine which book (or small subset of books) a verse is from without developing any deeper grammatical or stylistic understanding of the passage. To prevent simple word-level knowledge from driving the process, artificial counter-samples are used. In addition to providing similar verses with a score of 1, counter examples are generated where the order of one verse is reversed, and the target score is set to 0. In this way, the model will not be able to solely rely upon naïve word and word-frequency to determine if verses are similar. For training, each step consists of taking a verse and using it as the first verse in 10 verse pairs. For the second verse, 7 are chosen at complete random (and given a target score 0 or 1 as appropriate), 2 are chosen randomly from verses in the same book (target score 1), and 1 is created by taking a verse from the same book and reversing the word order (target score 0). Because we have imposed our own meaning onto how to interpret these outputs (the verses match or the verses don't match), the patterns the model develops internally take on meaning about the similarity of verses.

### 3.3 Siamese Network Model

A Siamese model architecture is used. It takes the two input verses and subjects them to an identical multi-layer encoding model (i.e. mapping them to a vector-space in the same way), and then puts the two encodings through a small similarity-checking module that will produce an input between 0 and 1. An epoch consists of systematically using each verse in the training set as the first verse for a step. Testing is done similarly, pulling from the test verses instead. The model was trained for 40 epochs. As a by-product of performing this verse-matching task, the model will develop a rich vector-space representation capable of distinguishing similar and dissimilar verses consistent with the definition implied by the data. The model will try to separate even very similar books (1 Samuel and 2 Samuel, or Matthew and Mark). Given a sufficiently large vector-space and training time, the model would approach a substantially complete separation between all books (although it would be frustrated by verses that appear identically between books), and no meaningful interrelationship between the books would be found. This can be thought of as memorizing the answers of the training data rather than developing actual intuition. By restricting the size of the vector-space, the model is forced to compromise in its learning, and books that are highly similar are not as well distinguished from another. This imperfect learning means that the patterns the model internally develops should carry generalizable meaning to be useful.

### 3.4 Results and Discussion

After training as discussed above, the model had an accuracy of 84.66% on the testing set and 83.61% on the training set for NIV. This is sufficient to ensure unrelated text is easily separated, but not so good that the model can distinguish between highly similar texts like 2 John and 3 John. Note that the training and test set sampling are enriched for sampling within the same book, so this model performance is not the same as comparing two verses at random. (Indeed, given 2 completely random verses, a naïve “they are consistently different” prediction would have ~92% accuracy.) After a model is trained, all verses of the Bible are passed through the encoding portion of the model to produce an encoding vector. For books and chapters, encodings are created by averaging and renormalizing the vectors of all verses they contain. Based on the similarity of encoding, it is possible to determine which books are most alike and establish a set of clusters. A dendrogram of the book-level hierarchical clustering using ward linkage for the NIV is shown in FIGS. 3A-3D.

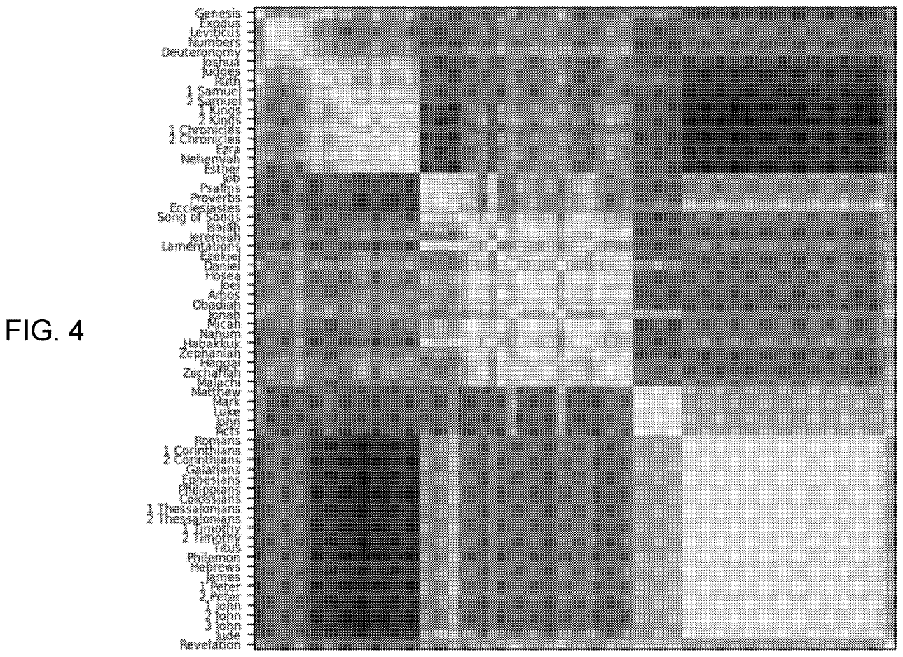

In simple terms, the diagram in FIG. 3A shows books and sets of books connected by horizontal lines, and the lower the connection occurs in the figure the more similar the book or set of books are to each other. It is possible to see, for example, that Mathew and Luke are highly similar and join at almost the lowest point possible. This is consistent with the fact they are describing the same set of events and often use similar language. Meanwhile, John is slightly separated from the other books of the Gospel because some of its descriptions and details are framed a little differently, but still connects to them at a fairly low level in the figure. However, it is advisable not to over-interpret the details of this figure. Ultimately, this figure attempts to collapse a 12-dimensional vector representation for each book in a single image. Most notably, Habakkuk is about as equally close to Lamentations as it is to Isaiah. A slight difference in closeness can cause Habakkuk to appear more like the poetic books or more like the prophets. Likewise, the relative similarity amongst the epistles fluctuates considerably as the majority are all very similar in style. FIG. 4 illustrates the similarity of all pairs of books as a heatmap.

Based on the combined information, the books are clustered into 11 clusters. The largest cluster is the main epistles. With few exceptions, the epistles are largely indistinguishable from one another in terms of style. The exceptions (2 Peter, Hebrews, James, and Jude) constitute the second cluster. These outlier epistles remain quite similar to the other epistles overall, but are sufficiently different to be distinguished from the main set. The third cluster is the poetic books. Despite high variation between the individual books, they are distinguishably separated from the other books. The fourth and fifth clusters are both old-testament prophets. Roughly, the prophets are separated into pre-exile and those whose writings that were concurrent or after the exile. The exact dates for writing do not exactly align with the separation of these clusters, suggesting that is not merely historical content, but something about the changes in the style of writing itself. Amos, in particular, stands out for being in Judah but still sounding more like the near-exile prophets. Two prophets do not cluster with either group, Jonah and Daniel. These two are instead in the sixth cluster along with Revelation. This apocalyptic prophecy cluster is the sole cluster that spans both the New and Old Testaments. The seventh and eighth clusters are Old Testament histories. The basis for the separation, like that for the two clusters of prophets, somewhat corresponds to date, but it is not within the scope of this disclosure to explore the basis, if any, for the separation. The ninth cluster is the Gospel plus Acts. The tenth cluster is the books of the law, containing the Pentateuch aside from Genesis. Finally, the eleventh cluster is the two remaining books of Genesis and Ruth. This narrative cluster tells a story with the heavy tone of historical record-keeping found in other Old Testament books.

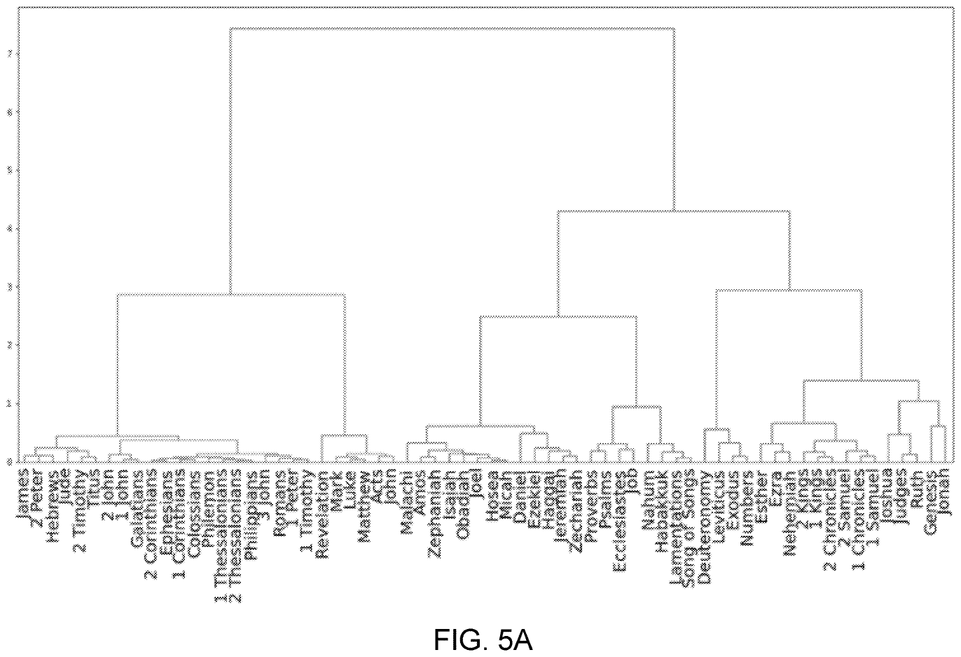

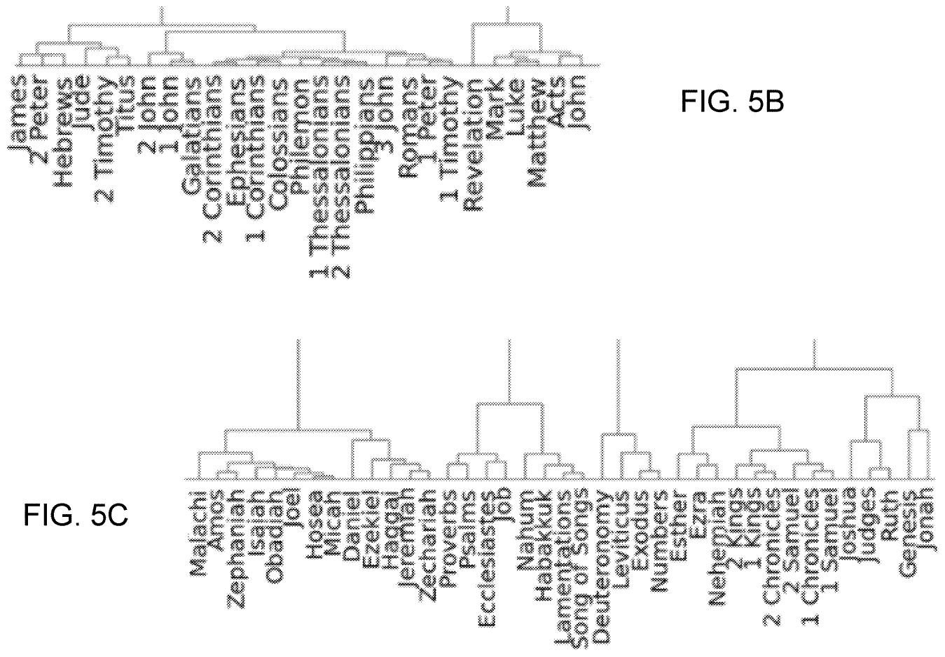

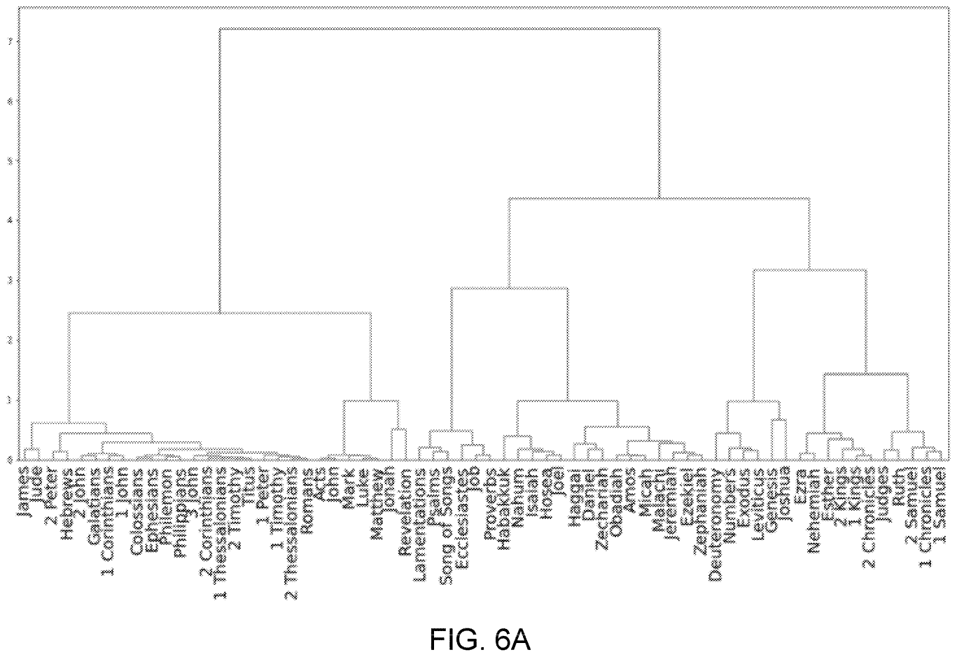

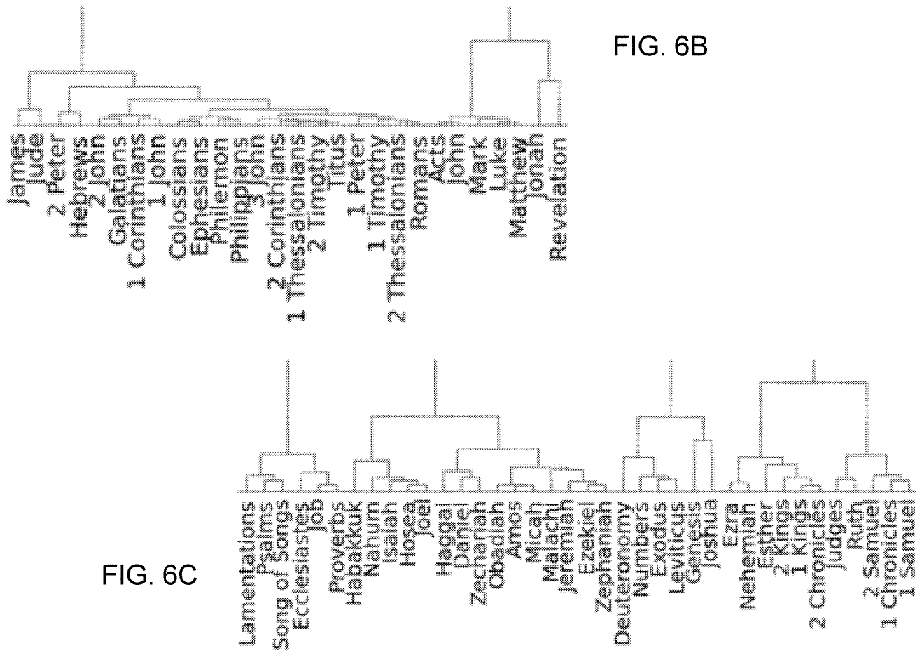

This clustering explanation is based primarily on the NIV. Looking at other languages, we would expect translations to largely remain faithful to each other. Dendrograms for the French Segond and the Indonesian AYT are shown in FIGS. 5A-5C and 6A-6C, respectively. The clustering derived from examination of the NIV results remains largely consistent with the results of other languages. This suggests the underlying character of these books survives translation in a consistent manner and that the methodology of identifying similarity between books is valid across multiple languages. The differences are few enough that they can be discussed in depth in just a few paragraphs. First, the apocalyptic cluster loses Daniel to the prophets in the Indonesian AYT and the cluster is substantially shattered in the French Segond. This suggests that this apocalyptic cluster as a general concept is somewhat fragile. Instead, it seems that Revelation is difficult to cluster. Aside from Jonah, the next closest matches are with the Gospels, which is such a highly self-similar group it is hard to imagine expanding their cluster to include Revelation. Second, while the book most similar to Genesis in NIV is Ruth, in the French Segond it is Jonah and in the Indonesian AYT it is Joshua. In general, the results suggest that Genesis does not fit in well with the Law cluster and is closer to the history books, but doesn't match with the style of books like Chronicles. The issue here is that creating discrete clusters is by its nature reductionist; it is a bit arbitrary where the exact boundaries lie of which book is closest. Instead, there is a continuum of books where the differences in translation make it unclear what is the best clustering possible. Third, the French Segond puts Habakkuk and Nahum as a new cluster with some of the poetic books.

The above-described embodiments provide a possible clustering of the books of the Bible. This clustering was based solely on the content of the books themselves and done by computational means. The methods employed did not depend upon the language of the text evaluated. The resulting clustering of books is largely in agreement with conventional wisdom, also highlighting some of the same points of tension as traditional analysis. Otherwise, the differences across languages are quite minor. Even some minor details (e.g. which epistles are outliers) remains consistent. The results presented were primarily at the book level, but the methodology itself provides insight for individual verses. Many books contain a range of thematic styles across their chapters.

### 4 Example Implementations of the Disclosed Technology

The above-described methodology can be used for the analysis of translations. Purpose-trained language models have the capacity to translate or evaluate translation into rare languages, but are generally limited by their training set. In an example, a model that requires more data than the Bible in order to evaluate the Bible is not helpful for rare languages. This analysis was performed on a Bible with no outside knowledge of the language on which the analysis was conducted. The ability to perform clustering in another language provides a way to validate the styles of writing within the new language. Additionally, the disclosed technology further enables determining how limited input sets can be used to build models capable of meaningful comparison before even a full Bible's worth of text is available. This could significantly enhance the accessibility and relevance of biblical texts to speakers of rare languages, allowing for more inclusive engagement with these works. Furthermore, this approach may offer insights into the cultural contexts in which different translations are received, helping to bridge gaps and foster understanding across diverse communities. By focusing on the intrinsic characteristics of the text rather than the language itself, researchers can gain a deeper appreciation of the universal themes and messages contained within the Bible.

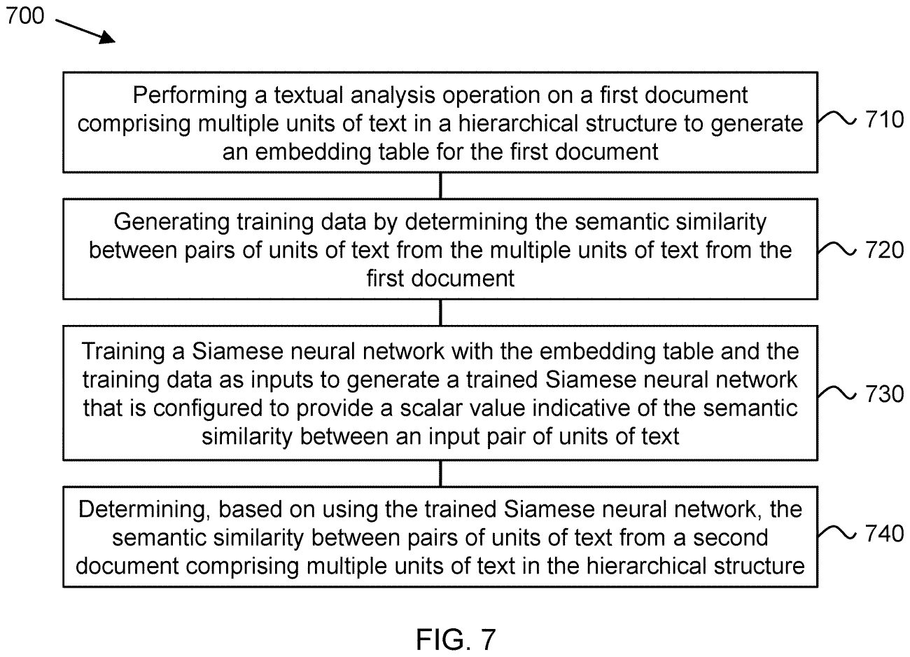

The described embodiments, methods, and systems can be implemented in the following preferred technical solutions:
S1. A method (e.g., method 700 in FIG. 7) for improving translation capabilities of hierarchically-organized documents based on semantic similarity, comprising: performing (710) a textual analysis operation on a first document comprising multiple units of text in a hierarchical structure to generate an embedding table for the first document; generating (720) training data by determining the semantic similarity between pairs of units of text from the multiple units of text from the first document, wherein the training data comprises (a) a positive semantic similarity sample generated based on two units of text from a same subsection of the first document and (b) a negative semantic similarity sample generated based on an original unit of text and an inverted unit of text generated by flipping an order of the original unit of text; training (730) a Siamese neural network with the embedding table and the training data as inputs to generate a trained Siamese neural network that is configured to provide a scalar value indicative of the semantic similarity between an input pair of units of text; and determining (740), based on using the trained Siamese neural network, the semantic similarity between pairs of units of text from a second document comprising multiple units of text in the hierarchical structure, wherein the sematic similarity enables an update to or a verification of a translation of the second document.
S2. The method of solution S1, wherein the embedding table is generated based on a continuous bag of words (CBOW) algorithm, and wherein a span parameter of the CBOW algorithm is configured based on a portion of the multiple units of text.
S3. The method of solution S2, wherein the CBOW algorithm is configured to operate on tokens from a machine-to-machine (M2M) model, and wherein the tokens are generated by a tokenizer designed for a transformer-based model.
S4. The method of solution S3, wherein the embedding table is generated based on generating an association matrix for each of the tokens, wherein the association matrix for a particular token encodes a plurality of tokens such that each of the plurality of tokens frequently co-occurs with the particular token at a common level of the hierarchical structure.
S5. The method of solution S4, wherein a dimensionality of the association matrix is reduced using principal component analysis (PCA) prior to the embedding table being generated.
S6. The method of solution S1, wherein an output vector size of the trained Siamese neural network ranges from 10 to 15.
S7. The method of solution S1, wherein, as part of training the Siamese neural network, a kernel constraint is applied to a dense layer of the Siamese neural network, thereby preventing an initial value of one or more weights in the dense layer from converging to zero.
S8. The method of solution S1, wherein the trained Siamese neural network is configured to be language-agnostic, and wherein determining the semantic similarity is independent of a language of the multiple units of text.
S9. The method of solution S1, wherein the first document is written in a first language and the second document is written in a second language different from the first language.
S10. The method of solution S9, wherein the hierarchical structure corresponds to the document being divided into books, chapters, and verses.
S11. The method of solution S10, wherein the hierarchical structure corresponds to the document being divided into books, chapters, and verses, wherein the first document comprises a Bible, and wherein the multiple units of text comprise the verses from the Bible.

Alternatively, the described embodiments, methods, and systems can be implemented in the following preferred technical solutions:
B1. A method for determining a semantic similarity, comprising: performing a textual analysis operation on a document comprising multiple units of text to generate an embedding table for the document; generating training data by determining the semantic similarity between units of text from a first subset of the multiple units of text, wherein the training data comprises a negative semantic similarity sample generating by flipping an order of a unit of text from the units of text from the first subset; and determining, based on using a Siamese neural network with the embedding table and the training data as inputs, the semantic similarity between units of text from a second subset of the multiple units of text.
B2. The method of solution B1, wherein the embedding table is generated based on a continuous bag of words (CBOW) algorithm, and wherein a span parameter of the CBOW algorithm is configured based on a portion of the multiple units of text.
B3. The method of solution B2, wherein the CBOW algorithm is configured to operate on tokens from a machine-to-machine (M2M) model, and wherein the tokens are generated by a tokenizer designed for a transformer-based model.
B4. The method of solution B1, wherein an output vector size of the Siamese neural network ranges from 10 to 15.
B5. The method of solution B1, wherein a kernel constraint is applied to a dense layer of the Siamese neural network, thereby preventing an initial value of one or more weights in the dense layer from converging to zero.
B6. The method of any of solutions B1 to B5, wherein determining the semantic similarity is independent of a language of the multiple units of text.
B7. The method of any of solutions B1 to B5, wherein the document comprises a Bible, and wherein the multiple units of text comprise verses from the Bible.
B8. A system comprising one or more processors configured to implement the method of any of claims B1 to B7.

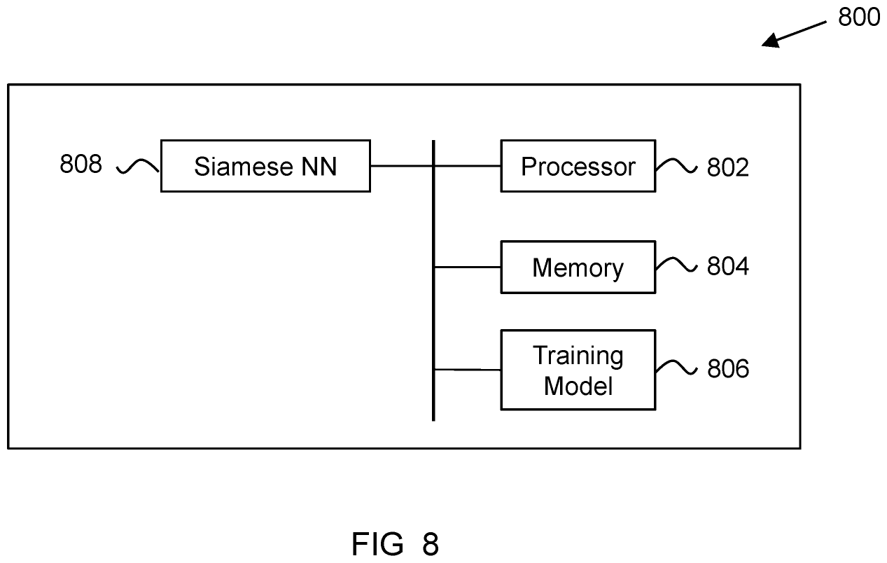

FIG. 8 shows an example of a hardware platform 800 that can be used to implement some of the techniques described in the present document. For example, the hardware platform 800 can implement the various modules and algorithms described herein. The hardware platform 800 includes a processor 802 that can execute code to implement a method. The hardware platform 800 includes a memory 804 that is used to store processor-executable code and/or store data. The hardware platform 800 further includes a training module 806 and a Siamese neural network 808, which can communicate with the processor 802. The processor 802 is configured to implement embedding lookup operations, data preparation, Siamese model encoding and/or computing Siamese model similarity. In some embodiments, the memory 804 comprises multiple memories, some of which are exclusively used by the processor 802 when implementing the data preparation and/or neural network algorithms.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and devices can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, these are optional. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for improving translation capabilities of hierarchically-organized documents based on semantic similarity, comprising:
performing a textual analysis operation on a first document comprising multiple units of text in a hierarchical structure to generate an embedding table for the first document;
generating training data by determining the semantic similarity between pairs of units of text from the multiple units of text from the first document,
wherein the training data comprises (a) a positive semantic similarity sample generated based on two units of text from a same subsection of the first document and (b) a negative semantic similarity sample generated based on an original unit of text and an inverted unit of text generated by flipping an order of the original unit of text;
training a Siamese neural network with the embedding table and the training data as inputs to generate a trained Siamese neural network that is configured to provide a scalar value indicative of the semantic similarity between an input pair of units of text; and
determining, based on using the trained Siamese neural network, the semantic similarity between pairs of units of text from a second document comprising multiple units of text in the hierarchical structure, wherein the semantic similarity enables an update to or a verification of a translation of the second document.

2. The method of claim 1, wherein the embedding table is generated based on a continuous bag of words (CBOW) algorithm, and wherein a span parameter of the CBOW algorithm is configured based on a portion of the multiple units of text.

3. The method of claim 2, wherein the CBOW algorithm is configured to operate on tokens from a machine-to-machine (M2M) model, and wherein the tokens are generated by a tokenizer designed for a transformer-based model.

4. The method of claim 3, wherein the embedding table is generated based on generating an association matrix for each of the tokens, wherein the association matrix for a particular token encodes a plurality of tokens such that each of the plurality of tokens frequently co-occurs with the particular token at a common level of the hierarchical structure.

5. The method of claim 1, wherein an output vector size of the trained Siamese neural network ranges from 10 to 15.

6. The method of claim 1, wherein, as part of training the Siamese neural network, a kernel constraint is applied to a dense layer of the Siamese neural network, thereby preventing an initial value of one or more weights in the dense layer from converging to zero.

7. The method of claim 1, wherein determining the semantic similarity is independent of a language of the multiple units of text.

8. The method of claim 1, wherein the first document is written in a first language and the second document is written in a second language different from the first language.

9. The method of claim 8, wherein the hierarchical structure corresponds to the first document being divided into books, chapters, and verses.

10. The method of claim 9, wherein the hierarchical structure corresponds to the first document being divided into books, chapters, and verses, wherein the first document comprises a Bible, and wherein the multiple units of text comprise the verses from the Bible.

11. A system for determining a semantic similarity within a document, comprising:
one or more processors and a memory including instructions stored thereupon, wherein the instructions upon execution by the one or more processors cause the one or more processors to:
generate an embedding table for a first document comprising multiple units of text in a hierarchical structure by performing a textual analysis operation on the first document;
generate training data by determining the semantic similarity between pairs of units of text from the multiple units of text from the first document, wherein the training data comprises (a) a positive semantic similarity sample generated based on two units of text from a same subsection of the first document and (b) a negative semantic similarity sample generated based on an original unit of text and an inverted unit of text generated by flipping an order of the original unit of text;
train a Siamese neural network with the embedding table and the training data as inputs to generate a trained Siamese neural network that is configured to provide a scalar value indicative of the semantic similarity between an input pair of units of text; and
determine, based on using the trained Siamese neural network, the semantic similarity between pairs of units of text from a second document comprising multiple units of text in the hierarchical structure, wherein the semantic similarity enables an update to or a verification of a translation of the second document.

12. The system of claim 11, wherein the embedding table is generated based on a continuous bag of words (CBOW) algorithm, wherein a span parameter of the CBOW algorithm is configured based on a portion of the multiple units of text, wherein the CBOW algorithm is configured to operate on tokens from a machine-to-machine (M2M) model, and wherein the tokens are generated by a tokenizer designed for a transformer-based model.

13. The system of claim 12, wherein the embedding table is generated based on generating an association matrix for each of the tokens, wherein the association matrix for a particular token encodes a plurality of tokens such that each of the plurality of tokens frequently co-occurs with the particular token at a common level of the hierarchical structure, wherein a dimensionality of the association matrix is reduced using principal component analysis (PCA) prior to the embedding table being generated.

14. The system of claim 11, wherein the first document is written in a first language and the second document is written in a second language different from the first language, and wherein the trained Siamese neural network is configured to be language-agnostic.

15. The system of claim 11, wherein, as part of training the Siamese neural network, the one or more processors is configured to:
apply a kernel constraint to a dense layer of the Siamese neural network, thereby preventing an initial value of one or more weights in the dense layer from converging to zero.

16. A device, comprising:
One or more processors;
a non-transitory computer-readable storage medium having instructions stored thereupon, wherein instructions upon execution by the processer cause the processor to::
perform a textual analysis operation on a first document comprising multiple units of text in a hierarchical structure to generate an embedding table for the first document;
generate training data by determining the semantic similarity between pairs of units of text from the multiple units of text from the first document,
wherein the training data comprises (a) a positive semantic similarity sample generated based on two units of text from a same subsection of the first document and (b) a negative semantic similarity sample generated based on an original unit of text and an inverted unit of text generated by flipping an order of the original unit of text;
train a Siamese neural network with the embedding table and the training data as inputs to generate a trained Siamese neural network that is configured to provide a scalar value indicative of the semantic similarity between an input pair of units of text; and
determine, based on using the trained Siamese neural network, the semantic similarity between pairs of units of text from a second document comprising multiple units of text in the hierarchical structure, wherein the semantic similarity enables an update to or a verification of a translation of the second document.

17. The device of claim 16, wherein an output vector size of the trained Siamese neural network ranges from 10 to 15.

18. The device of claim 16, wherein the first document is written in a first language and the second document is written in a second language different from the first language.

19. The device of claim 18, wherein the hierarchical structure corresponds to the document being divided into books, chapters, and verses.

20. The device of claim 19, wherein the hierarchical structure corresponds to the document being divided into books, chapters, and verses, wherein the first document comprises a Bible, and wherein the multiple units of text comprise the verses from the Bible.
